(19) United States
(12) Patent Application Publication
(10) Pub. No.: US 2026/0348233 A1
(43) Pub. Date: Nov. 5, 2026

(54) Radial Blinds-Window Covering System for Round or Half-Round Openings Using a Curved Track and Rod to Fan Between Open and Closed

(71) Applicant: Stacey Martinez, Longview, TX (US)

(72) Inventor: Stacey Martinez, Longview, TX (US)

(73) Assignee: Stacey Martinez, Longview, TX (US)

(21) Appl. No.: 19/198,106

(22) Filed: May 4, 2025

(51) Int. Cl. E06B 9/262; E06B 9/24

(52) U.S. Cl. CPC E06B 9/262; E06B 2009/2488; E06B 2009/2625

(57) ABSTRACT

This fan-style window covering is a more economical and unique method of covering half-circle or circular windows and openings, utilizing a series of bars to fan out along a curved track to open and close the covering. This window covering consists of a curved track attached to the window frame which remains stationary. Behind the curved track is the fan-style curtain, which consists of material fastened to a set of bars joined together at their ends, so that they fan open and closed around that joining point. A rod on the end of at least one of the bars allows for the end bar to be moved along the curved track, which extends the curtain when fanned open to cover the window, and bunches up the curtain when it is fanned closed in the opposite direction to uncover the window.

### FIGURE DESCRIPTIONS

FIG. 1—A sketch showing an isometric view showing the window covering system, with descriptive labels pointing to the various components.

FIG. 2—A sketch showing an isometric view of the curtain fanned out to cover the window or opening. This figure shows the parts of this system—the fan-style curtain with the bars underneath visible, the curved track that attaches to the window frame and remains stationary, and the rod that moves the curtain along the curved track to fan it open and closed.

FIG. 3—A sketch showing the same isometric view and curtain components from FIG. 1, this time with the rod moved to the opposite end of the curved track, which folds up the curtain material to uncover the window or opening.

FIG. 4—A photograph of the prototype curtain fanned out to cover the window opening.

### BACKGROUND

This invention came about while the inventor was attempting to find a way to reduce heat in a bedroom in her home due to a very large, open half-circle shaped window. Window blinds for half-round windows currently raise up from the diameter of the half-round section to cover the opening. The commercially available options were custom, often powered by a motor, difficult to operate manually, and expensive. The inventor was looking for a way to block out the light and heat of the direct sun in a more economical fashion that would allow for a person to open and close the window covering easily, since the window has a good view during other times of the day when it is not experiencing direct sunlight. After finding no economical options, the inventor was inspired by a paper fan, to have a curtain that could fan out to cover the half circle shaped window, and fold back when the curtain is not needed. The same method can be used to cover any half circle or full circle shaped opening using this style of track, rod, and curtain.

### DETAILED DESCRIPTION

To create the fan-out style curtain, first fasten together bars at a single point on one end to allow these bars to fan open and closed in a half circle or circle. Fabric or other material can be fastened to the bars in a way that allows the curtain material to move with the bars as they fan open and closed. One bar on the end of this fan-out style curtain will be fixed in position to the window frame or opening this curtain will be covering using fasteners or brackets. The flat bar on the opposite end from the fixed bar on this fan-out style curtain needs to have a rod attached to it, perpendicular to the flat bar. This rod extends through a curved slot in a track installed around the opening that is being covered by this curtain. After extending through the slot, the rod can be fastened to a pull rod for manual opening or a motor that drives along the track for motorized opening, which will fan out the curtain. The same pull rod or motor can be moved in the opposite direction to close the curtain and fold it back together, revealing the window or opening underneath.

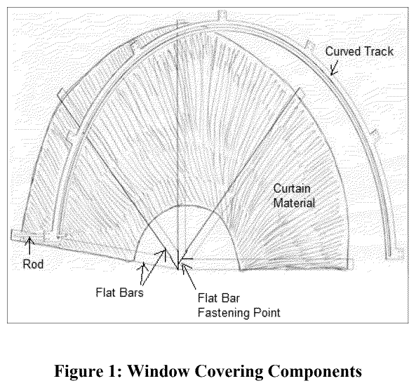

FIG. 1 below shows an isometric view of these components with their descriptive labels to identify the different parts of this design.

### FIG. 1: Window Covering Components

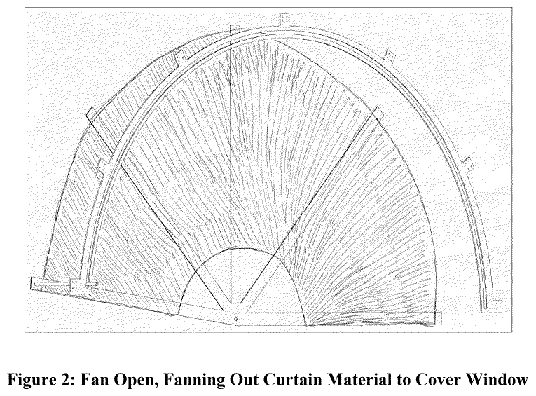

FIG. 2 below shows the bars fanned out to their open position, which fans out the curtain material (shown with a hatched line pattern between the bars) to cover the window or opening.

### FIG. 2: Fan Open, Fanning Out Curtain Material to Cover Window

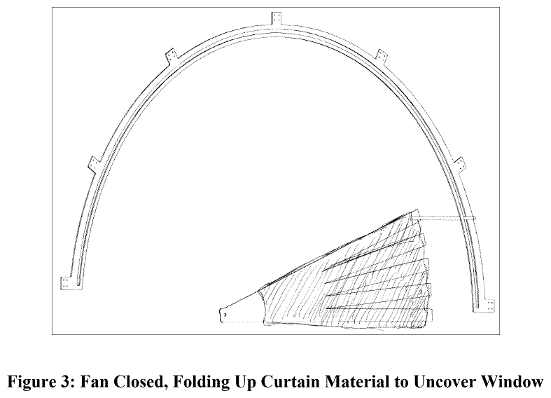

FIG. 3 below shows the rod moved to the opposite end of the curved track around the window, which folds up the curtain material between the bars, uncovering the window opening.

### FIG. 3: Fan Closed, Folding Up Curtain Material to Uncover Window

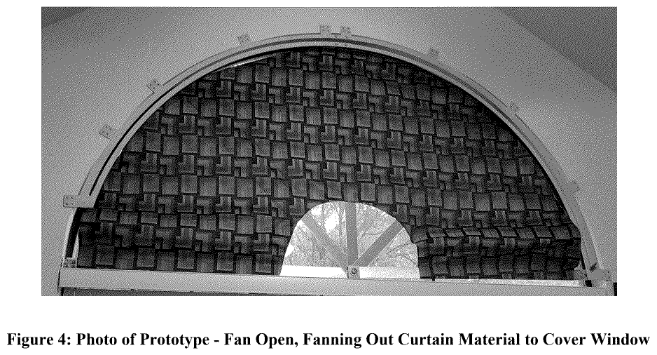

### FIG. 4: Photo of Prototype—Fan Open, Fanning Out Curtain Material to Cover Window

1. I claim the ornamental design for the fan-out style window covering as shown and described.

2. I claim the window covering system described, comprising:
a. The curved track attached to the window frame; and
b. The fan-out style curtain with rod that moves along the curved track to open and close.
